(19) United States
(12) Patent Application Publication
(10) Pub. No.: US 2023/0178083 A1
(43) Pub. Date: Jun. 8, 2023

(54) AUTOMATICALLY ADAPTING AUDIO DATA BASED ASSISTANT PROCESSING

(71) Applicant: GOOGLE LLC, Mountain View, CA (US)

(72) Inventors: Matthew Sharifi, Kilchberg (CH); Victor Carbune, Zurich (CH)

(21) Appl. No.: 17/541,995

(22) Filed: Dec. 3, 2021

(51) Int. Cl. G10L 17/22; G10L 17/14

(52) U.S. Cl. CPC G10L 17/22; G10L 17/14

(57) ABSTRACT

Implementations relate to at least intermittently processing dynamic contextual parameters and dynamically automatically adapting, in dependence on the processing of the dynamic contextual parameters, audio data processing that is performed at an assistant device. The dynamic and automatic adapting of the audio data processing mitigates occurrences of false positives and/or false negatives in hot word processing, invocation-free speech recognition, and/or other automated assistant audio data based processing techniques. Implementations dynamically automatically adapt the audio data processing between two or more states and the automatic adaptation of the audio data processing from a current state to an alternate state is in response to the processing, of current values for the dynamic contextual parameters, satisfying one or more conditions.

### BACKGROUND

Humans can engage in human-to-computer dialogs with interactive software applications referred to herein as “automated assistants” (also referred to as “chatbots,” “interactive personal assistants,” “intelligent personal assistants,” “personal voice assistants,” “conversational agents,” etc.). For example, humans (which when they interact with automated assistants may be referred to as “users”) can provide commands/requests to an automated assistant using spoken natural language input (i.e., spoken utterances), which can in some cases be converted into text and then processed, and/or by providing textual (e.g., typed) natural language input. An automated assistant generally responds to a command or request by providing responsive user interface output (e.g., audible and/or visual user interface output), controlling smart device(s), and/or performing other action(s).

As mentioned above, many automated assistants are configured to be interacted with via spoken utterances. To preserve user privacy and/or to conserve resources, an automated assistant can refrain from performing one or more automated assistant functions based on all spoken utterances that are present in audio data detected via microphone(s) of an assistant device (i.e., a client device that implements (at least in part) the automated assistant). Rather, certain processing, that is based on audio data that captures a spoken utterance, is performed by the automated assistant only in response to determining certain condition(s) are present.

For example, many assistant devices include a hot word detection model. When microphone(s) of an assistant device are not deactivated, the assistant device can continuously process audio data detected via the microphone(s), using the hot word detection model, to generate predicted output that indicates whether one or more hot words (inclusive of multi-word phrases) are present. For example, the predicted output can be a probability that indicates whether one or more hot words are present. For instance, the hot word can be determined to be present when the probability satisfies a threshold. When the predicted output indicates that a hot word is present, further certain assistant processing can be performed. However, when the predicted output indicates that a hot word is not present, corresponding audio data will be discarded without performing the further certain assistant processing.

For example, an assistant invocation hot word detection model can be utilized to detect whether hot word(s) for invoking an automated assistant are present, such as “Hey Assistant,” “OK Assistant”, and/or “Assistant”. When predicted output, generated using the assistant invocation hot word detection model, indicates one of the hot word(s) is present, then further assistant processing can be performed. For example, when the predicted output indicates one of the hot word(s) is present, audio data that follows and/or precedes within a threshold amount of time of the hot word (and optionally that is determined to include voice activity) can be processed by one or more on-device and/or remote automated assistant components, such as speech recognition component(s). Further, recognized text (from the speech recognition component(s)) can be processed using natural language understanding (NLU) engine(s) and/or action(s) can be performed based on NLU output generated using the NLU engine(s). The action(s) can include, for example, generating and providing a response and/or controlling one or more application(s) and/or smart device(s)).

As another example, an action hot word detection model can be at least selectively utilized to detect when hot word(s), for directly invoking a particular action via the automated assistant, are present in audio data. When predicted output, generated using the action hot word detection model, indicates one of the hot word(s) is present, then further assistant processing of invoking the particular action can be performed. For instance, when there is an incoming voice and/or video call at an assistant device, an action hot word detection model can be utilized to detect whether “answer” is present in audio data and, when “answer” is detected, the automated assistant can directly invoke an answer action, thereby causing the incoming voice and/or video to be answered. Also, for instance, an action hot word detection model can be utilized to detect whether “play music” is present in audio data and, when “play music” is detected, the automated assistant can directly invoke a particular music streaming service to play music, thereby causing music from the particular music streaming service to begin streaming at the assistant device. As yet another instance, an action hot word detection model can be utilized to detect whether “OK Example” is present in audio data and, when “OK Example” is detected, the automated assistant can invoke a particular third party application (with an alias of “Example”), thereby causing the particular third party application to engage in a dialog with the user, via the automated assistant, in furtherance of performing action(s) via the particular third party application.

Hot word detection models perform well in many situations, accurately distinguishing between audio data that includes a hot word and audio data that does not include a hot word. However, there are still situations where further assistant processing is performed, in response to detection of a hot word using a hot word detection model, despite there being no user intent for the further assistant processing to be performed. Occurrence of such a situation is referenced herein as a “false positive”. In addition to privacy concerns, a false positive can waste network and/or computational resources by needlessly performing the further assistant processing.

As one example, assume that “Vivian” is a hot word for invoking an automated assistant or for directly invoking a particular action via the automated assistant, and that a given assistant device includes a hot word detection model used to monitor for occurrence of the hot word. Further assume that the given assistant device is located near a laptop of a user, and that the user is utilizing microphone(s) and speaker(s) of the laptop to engage in a video call with multiple participants, including a participant named Vivian. The automated assistant or the particular action can be inadvertently invoked responsive to the user, or another participant, speaking the word “Vivian” during the video call. This can waste network and/or computational resources by needlessly performing the further assistant processing. While the assistant device may include a hardware or software button for manually deactivating microphone(s) of the assistant device and thereby preventing this situation, the user may have forgotten to deactivate the microphone(s). Further, manually deactivating the microphone(s) and subsequently forgetting to manually reactivate the microphone(s) can result in subsequent false negative situation(s), described in more detail below.

As another example, assume “Poodle” is a hot word for invoking an automated assistant or a particular action via the automated assistant, and a given assistant device includes a hot word detection model used to monitor for occurrence of the hotword. Further assume a user speaks “Noodle” near the given assistant device. The automated assistant or the particular action can be inadvertently invoked responsive to the user speaking “Noodle”. This can be due to the predicted output, generated using the hot word detection model, incorrectly indicating that “Poodle” was spoken. For example, assume the predicted output is a probability and the probability must be greater than a 0.80 threshold before the further assistant processing is performed. Despite “Noodle” being spoken, the generated probability can be 0.81, which causes the further assistant processing to be performed. This can waste network and/or computational resources by needlessly performing the further assistant processing. While some assistant devices enable an option for manually adjusting the threshold (e.g., it can be increased or decreased relative to 0.80), the user may not be aware of the option or may not have utilized the option. Further, once manually adjusted, the threshold remains static until another manual adjustment, and the threshold is common for all users of the assistant device. Yet further, manual adjustments that increase the threshold can lead to an increase in false negatives, while those that decrease the threshold can lead to an increase in false positives.

Moreover, there are also situations where further assistant processing is not performed responsive to a spoken utterance of a user, despite there being user intent for the further assistant processing to be performed and despite the audio data (that captures the spoken utterance) being appropriate for causing the further assistant processing to be performed. An occurrence of such a situation is referenced herein as a “false negative”. A false negative can prolong the human / automated assistant interaction, forcing the human to repeat the utterance (and/or perform other action(s)) that were initially intended to activate automated assistant function(s).

For example, assume the predicted output generated using a hot word detection model is a probability and that the probability must be greater than a 0.85 threshold before the further assistant processing is performed. Further assume a spoken utterance captured in audio data indeed includes a hot word corresponding to the hot word detection model, but that the predicted probability generated based on processing the audio data, using the hot word detection model, is only 0.82. In such a situation, the function(s) will not be activated (since 0.82 is not greater than 0.85), resulting in a false negative. Occurrences of false negatives can prolong the human / automated assistant interaction, forcing the human to repeat the utterance (and/or perform other action(s)) that were initially intended to activate automated assistant functions.

Some automated assistants additionally or alternatively at least selectively implement an invocation-free mode that can be enabled. When enabled at an assistant device, the invocation-free free mode can result in the assistant device processing any spoken utterance that is detected via microphone(s) of the client device and determining whether the spoken utterance is intended for the assistant or, instead, is not intended for the assistant (e.g., spoken utterances that are instead directed to another human). In discriminating between spoken utterances that are intended for the assistant and those that are not, audio data capturing the spoken utterance can be processed using a machine learning model. The audio data can optionally be processed along with recognized text from speech recognition performed on the spoken utterance and/or representation(s) thereof (e.g., natural language understanding data generated based on the recognized text). Predicted output is generated based on the processing, and indicates whether the spoken utterance is intended for the automated assistant. Certain further automated assistant processing is performed only when the predicted output indicates the spoken utterance is intended for the automated assistant. Otherwise, the certain further automated assistant processing is not performed, and data corresponding to the spoken utterance is discarded. The certain further automated assistant processing can include, for example, further verification that the spoken utterance is intended for the automated assistant and/or performing action(s) based on the spoken utterance.

Machine learning model(s) for discriminating between spoken utterances that are intended for the assistant and those that are not perform well in many situations, accurately distinguishing between those two types of spoken utterance. However, there are still false positive situations where further assistant processing is performed in response to determining a spoken utterance is intended for the assistant, despite there being no user intent for the further assistant processing to be performed. Moreover, there are still false negative situations where further assistant processing is not performed, despite there being user intent for the further assistant processing to be performed.

### SUMMARY

Implementations disclosed herein are related to at least intermittently processing dynamic contextual parameters and dynamically automatically adapting, in dependence on the processing of the dynamic contextual parameters, audio data processing that is performed at an assistant device. The dynamic and automatic adapting of the audio data processing according to implementations disclosed herein mitigates occurrences of false positives and/or false negatives in hot word processing, invocation-free speech recognition, and/or other automated assistant audio data based processing techniques. Mitigating the occurrence of false positives can mitigate privacy concerns and/or conserve computational and/or network resources by preventing inadvertent particular audio data based assistant processing. Mitigating the occurrence of false negatives can enable more efficient human / automated assistant interaction by mitigating occurrences of corresponding users repeating an utterance and/or performing other action(s) that were intended to activate automated assistant functions.

Implementations dynamically automatically adapt the audio data processing between two or more states. The automatic adaptation of the audio data processing from a current state to an alternate state is in response to the processing, of current values for the dynamic contextual parameters, satisfying one or more conditions. For example, the current values for the dynamic contextual parameters can be processed using one or more trained machine learning models to generate output that indicates which, of the two or more states, should be active in view of the current values. In such an example, satisfaction of the condition(s) can include that the output indicates that the alternate state should be active in lieu of the currently active current state. Also, for example, the current values for the dynamic contextual parameters can additionally or alternatively be processed using one or more rules (e.g., defined by registered user(s) of the assistant device) that are each for a corresponding state, to determine whether the rule is satisfied. In such an example, satisfaction of the condition(s) can include the processing indicating that a rule, for the alternate state, is satisfied.

In response to satisfaction of the condition(s), the audio data based processing can be adapted from the current state to the alternate state. The adaptation can be automatic. That is, the instance of adaptation from the current state to the alternate state can be performed independent of receiving any explicit user interface input that requests or confirms the instance of adaptation. In these and other manners, false positives and/or false negatives can be mitigated or the human / automated assistant interaction otherwise improved through an instance of an adaptation - and without requiring user interface input(s) to effectuate that instance of the adaptation. In some implementations, although the adaptation is automatic, user interface output(s) can be rendered in response to the adaptation and can optionally reflect the alternate state to which the audio data based processing was adapted. This can inform user(s) of the assistant device of the adaptation.

Further, in some of those implementations further user interface input can be provided, in response to the user interface output(s), to provide feedback. The feedback can be, for example, feedback that the adaptation was correct, feedback that an alternate adaptation should have been made, or feedback that no adaptation should have been made. For example, the feedback can be via spoken input and/or via interaction with graphical interface element(s) that facilitate the feedback. The feedback can be utilized to adapt (e.g., for at least the assistant device), the machine learning model(s) and/or rule(s) on which the adaptation was based. In these and other manners, accuracy and/or robustness of future adaptations can be improved. Additionally or alternatively, feedback that indicates no adaptation or an alternate adaptation should have been made can be used to further immediately adapt the audio data based processing to the prior current state or to another alternate state. This can facilitate the human / automated assistant interaction to ensure that the current adaptation is correct.

As one particular example of implementations disclosed herein, the automatically adapting can be to or from at least a fully active state, a partially active state, and/or an inactive state. In the fully active state, the particular audio data based assistant processing is fully performed for one or more registered users that are registered with the assistant device (e.g., have a user profile stored at and/or in association with the assistant device) and is also fully performed for any users that are not registered with the assistant device (e.g., so-called “guest” users). In the partially active state, the particular audio data based assistant processing is fully performed for the one or more registered users, but at least part of the particular audio data based assistant processing is suppressed for any users that are not registered with the assistant device. In the inactive state, the at least part of the particular audio data based assistant processing is suppressed for the one or more registered users and is also suppressed for any users that are not registered with the assistant device.

For instance, assume the audio data based processing is invocation hot word processing. In the fully active state, a stream of audio data can be processed to monitor for occurrence of an invocation hot word and, in response to detecting occurrence of the invocation hot word, further assistant processing can be performed. The further assistant processing can include, for example, automatic speech recognition (ASR) to generate a recognition of a spoken utterance that precedes and/or follows the hot word, natural language understanding (NLU) based on the recognition, and/or fulfillment based on NLU data generated based on performing the NLU. Notably, in the fully active state, the further assistant processing is performed in response to detecting occurrence of the invocation hot word, and is performed when a registered user spoke the hot word as well as when a guest spoke the hot word.

The partially active state can be similar to the fully active state. However, in the partially active state the ASR, NLU, and/or fulfillment can be suppressed when the hot word is determined to not have been spoken by a registered user. For example, text-dependent speaker identification (TDSID) and/or text independent speaker identification (TISID) can be utilized to determine whether the hot word and/or the spoken utterance (that precedes and/or follows the hot word) is from a registered user. Performance of the ASR, NLU, and/or fulfillment can be contingent on verifying that the hot word and/or the spoken utterance is from the registered user. Vision based facial verification can additionally or alternatively be utilized in determining whether the hot word and/or the spoken utterance is from the registered user.

In the inactive state, processing of the stream of audio data to monitor for occurrence of the invocation hot word can be fully deactivated for all users. In some implementations, although processing of the stream of audio data to monitor for occurrence of the invocation hot word is suppressed, the stream of audio data can optionally be processed for one or more other purposes, such as generating value(s) for current activity contextual parameters described herein. Accordingly, in those implementations the microphone(s) of the assistant device are not fully disabled for all purposes.

As another particular example of implementations disclosed herein, the automatically adapting can be to or from at least a first threshold state and a second threshold state. In the first threshold state one or more first thresholds are utilized for the particular audio data based assistant processing, whereas one or more different second thresholds are utilized for the particular audio data based assistant processing in the second threshold state.

For instance, assume the audio data based processing is invocation-free speech recognition processing. In both the first threshold state and second threshold state, speech recognition can be performed on audio data that captures a spoken utterance (e.g., as indicated by voice activity detection) to generate a recognition of the spoken utterance. Further, in both states the recognition and/or the audio data can be processed (e.g., using machine learning model(s)) to generate output(s) that indicate whether the spoken utterance is an assistant command. In the first threshold state, the output(s) are compared to first threshold(s) in determining whether the spoken utterance is an assistant command. In the second threshold state, the output(s) are compared to second threshold(s) in determining whether the spoken utterance is an assistant command. In both states, further assistant processing can be performed only responsive to determining the spoken utterance is the assistant command. For example, the further assistant processing can include performing NLU based on the recognition and/or performing fulfillment based on NLU data from the NLU. As noted, different thresholds are utilized in the first and second threshold states in making the determination as to whether to perform further assistant processing. Accordingly, the determination is more restrictive in one of the first and second threshold states and is less restrictive in the other. Thus, in the less restrictive of the states a given spoken utterance can be determined to be directed to an automated assistant whereas, in the more restrictive state, the same given spoken utterance can be determined to not be directed to an automated assistant.

Additional and/or alternative states and/or adaptations can be utilized beyond those provided in the preceding examples. For instance, states can include a first threshold fully active state, a second threshold fully active state, a first threshold partially active state, a second threshold partially active state, and an inactive state. Also, for instance, states can include a first threshold fully active state, a second threshold fully active state, a third threshold fully active state, and an inactive state.

As referenced above, automatic adaptations described herein are based on processing of current values for dynamic contextual parameters. In some implementations, the dynamic contextual parameters include registered user parameter(s), current activity parameter(s), and/or a temporal parameter(s).

Registered user value(s) for registered user parameter(s) can indicate whether one or more registered users are present in an environment of the assistant device and/or can indicate which of the one or more registered users are present in the environment. For example, TISID can be performed, locally at the assistant device and by processing audio data using TISID model(s), to determine whether and/or which registered user(s) are currently present near the assistant device, and the registered user value(s) can reflect that determination. Also, for example, vision based (e.g., based on vision data from vision component(s) of the assistant device) facial verification can additionally or alternatively be performed, locally at the assistant device, to determine whether and/or which registered user(s) are currently present near the assistant device, and the registered user value(s) can reflect that determination.

Current activity value(s) for current activity parameter(s) can indicate whether one or more activities are occurring in the environment and/or can indicate which of the one or more activities are occurring in the environment. For example, a calendar entry of a registered user can be accessed, by the assistant device, to determine the user is in a video call, and the current activity value can reflect generally that a registered user is engaged in an activity or, more particularly, that the user is in a meeting or video call. As another example, a stream of audio data from microphone(s) of the assistant device can be processed, locally at the assistant device, to determine presence of sound(s) that indicate occurrence of a particular activity, and the current activity value can reflect generally that an activity is occurring or, more particularly, reflect the particular activity. For example, an “eating” activity can be inferred based on local processing of a stream of audio data indicating the presence of cutlery sounds, and the current activity value can reflect the particular eating activity.

Current temporal value(s) for temporal parameter(s) can indicate one or more current temporal conditions such as time of day (e.g., specific such as 9:00am or general such as morning), a day of the week (e.g., Monday, Tuesday, etc.), a day of the year (e.g., 23^{rd} of December), or month.

As also referenced above, in various implementations the processing of current values for dynamic contextual parameters can be via trained machine learning model(s) and/or rule(s). In some implementations, the trained machine learning model(s) can be trained based on supervised or semi-supervised training examples, such as those generated based on past interactions with an automated assistant and/or those generated based on instances of feedback received responsive to automatic adaptations described herein. The machine learning model(s) used on an assistant device can optionally be trained, exclusively or partially, based on training examples generated from use of the assistant device and/or other assistant device(s) that are explicitly linked with the assistant device (e.g., those belonging to the same registered user(s)).

As a non-limiting example, assume a trained machine learning model that is trained to process contextual value(s) and generate output that indicates a likelihood that a user will interact with an automated assistant given the contextual value(s). For example, the output can be a probability from 0 to 1, with higher values indicating increased likelihood of interaction. In this example, an assistant device can be adapted to a first threshold state (if not already in it) when the output is greater than 0.6, and adapted to a second threshold state (if not already in it) otherwise. The first threshold state can utilize first threshold(s) that are less restrictive than second threshold(s) utilized in the second threshold state. In this example, positive training examples can be generated based on prior instances in which assistant interactions occurred without being cancelled or interrupted. For example, each positive training example can include, as input, contextual value(s) that reflect context at one of those instances and, as output, a value of “1”. In this example, negative training examples can optionally be generated based on prior instances in which assistant interactions were initiated but quickly cancelled or interrupted (e.g., inferring a false positive situation). For example, each negative training example can include, as input, contextual value(s) that reflect context at one of those instances and, as output, a value of “0”. Training examples can additionally or alternatively be generated based on instances of feedback described herein.

As another non-limiting example, assume a trained machine learning model that is trained to process contextual value(s) and generate output that indicates a first likelihood for a fully active state, a second likelihood for a partially active state, and a third likelihood for a fully inactive state. For example, each of the outputs can be a probability from 0 to 1, with higher values indicating increased likelihood of interaction, and the probabilities can be normalized (e.g., via softmax). In this example, an assistant device can be adapted to a corresponding one of the three states (if not already in it) when the likelihood for that state is greater than the likelihood for the other two states and, optionally, if it satisfies some threshold (e.g., 0.5) and/or other condition(s) are satisfied. In this example, positive training examples can be generated based on prior instances in which a user confirmed one of the three states via feedback and/or other means. For example, each positive training example can include, as input, contextual value(s) that reflect context at one of those instances and, as output, a value of “1” for the confirmed state and a value of “0” for the other two states.

In implementations where rules are utilized, they can be utilized in combination with or in lieu of machine learning model(s). For example, in determining whether to adapt audio data based processing at a given instance, a rule can be utilized if that rule is satisfied given the current contextual conditions at the given instance and, otherwise, machine learning model(s) can be utilized. As one non-limiting example of a rule, a user can specify “turn off invocation-free speech processing during dinner on weekdays”. In response, a rule can be generated that causes invocation-free speech processing to be in an inactive state on weekdays and when ambient noise detection and/or other signal(s) (e.g., a smart oven indicating cooking is complete) indicate “dinner” is occurring. As another non-limiting example of a rule, a user can specify “restrict hot word invocation to me whenever I’m in a videoconference”. In response, a rule can be generated that causes invocation hot word processing to be in a partially active state when the user is in a videoconference (e.g., as reflected by the user’s calendar).

In some implementations, when an ecosystem of smart devices are provided and linked to one another (e.g., via a home graph and/or via registration with common user account(s)), each of the assistant devices can determine and implement its own adaptations, and can optionally have machine learning model(s) and/or rules, utilized in the adaptations, that are tailored to the assistant device. In some other implementations, an adaptation at one assistant device can result in the same adaptation at other assistant device(s) in the ecosystem. For example, the one assistant device can, responsive to adapting to a given state, communicate with one or more linked assistant devices to cause them to also transition to the given state.

The above is provided merely as an overview of some implementations. Those and/or other implementations are disclosed in more detail herein.

### BRIEF DESCRIPTION OF THE DRAWINGS

FIG. 1 is a block diagram of an example computing environment in which implementations disclosed herein may be implemented.

FIG. 2 is a flowchart illustrating an example method of automatically adapting audio data based assistant processing in dependence on contextual parameters.

FIG. 3 is a flowchart illustrating an example method of performing invocation hot word processing in dependence on a currently active state.

FIG. 4 is a flowchart illustrating an example method of performing action hot word processing in dependence on a currently active state.

FIG. 5 is a flowchart illustrating an example method of performing invocation-free speech processing in dependence on a currently active state.

FIG. 6A, FIG. 6B, FIG. 6C, FIG. 6D, and FIG. 6E illustrate an example assistant device and examples of rendering user interface outputs that reflect a current automatically adapted state of audio data based assistant processing, as well as rendering feedback user interface elements.

FIG. 7 illustrates an example architecture of a computing device.

### DETAILED DESCRIPTION

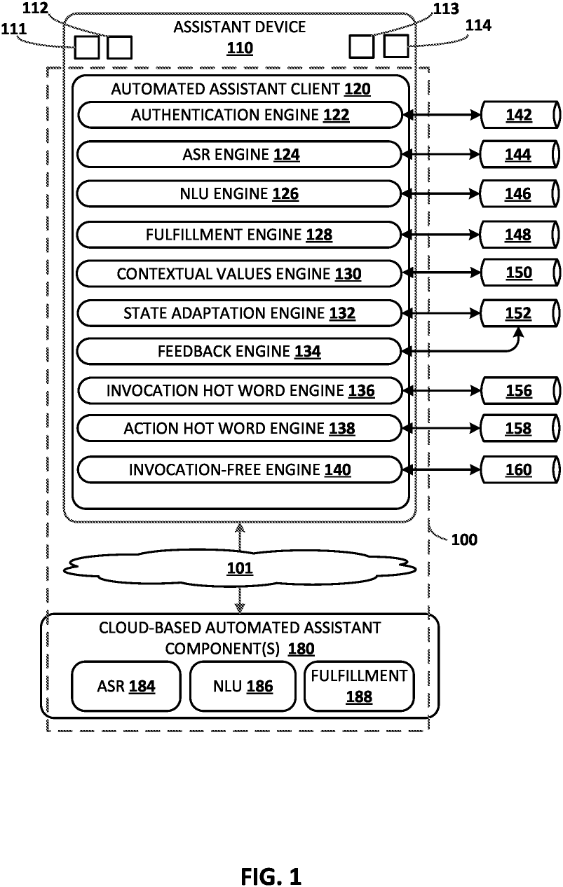

Turning initially to FIG. 1, an example environment is illustrated in which various implementations can be performed. FIG. 1 includes an assistant device 110 that at least selectively executes an instance of an automated assistant client 120. An assistant device, as used herein, is a client device executing an automated assistant client and/or via which an automated assistant is otherwise accessible. One or more cloud-based automated assistant components 180 can be implemented on one or more computing systems (collectively referred to as a “cloud” computing system) that are communicatively coupled to assistant device 110 via one or more local and/or wide area networks (e.g., the Internet) indicated generally at 101.

An instance of an automated assistant client 120, optionally via interaction(s) with one or more of the cloud-based automated assistant components 180, can form what appears to be, from the user’s perspective, a logical instance of an automated assistant with which the user may engage in a human-to-computer dialog. An instance of such an automated assistant 100 is depicted in FIG. 1.

The assistant device 110 can be, for example: a desktop computing device, a laptop computing device, a tablet computing device, a mobile phone computing device, a computing device of a vehicle (e.g., an in-vehicle communications system, an in-vehicle entertainment system, an in-vehicle navigation system), a standalone interactive speaker, a standalone interactive speaker with a display, a smart appliance such as a smart television, and/or a wearable apparatus that includes a computing device (e.g., a watch having a computing device, glasses having a computing device, a virtual or augmented reality computing device).

Assistant device 110 can be utilized by one or more users within a household, a business, or other environment. Further, one or more users may be registered with the assistant device 110 and each registered user can have a corresponding user account accessible via the assistant device 110. The user account, for a registered user, can include, for example, verification features for the registered user such as TDSID feature(s) (e.g., embedding(s)), TISID feature(s) (e.g., embedding(s)), and/or facial feature(s) (e.g., embedding(s)) that are utilized in verifying whether a spoken utterance is from the registered user.

The assistant device 110 in FIG. 1 is illustrated as including or more microphones 111, one or more speakers 112, one or more cameras and/or other vision component(s) 113, and one or more displays 114 (e.g., a touch-sensitive display). The client device 110 may further include pressure sensor(s), proximity sensor(s), accelerometer(s), magnetometer(s), and/or other sensor(s). Sensor data from microphone(s) 111, vision component(s) 113, and/or other sensor(s) can be processed in generating values for contextual feature(s) described herein.

The automated assistant client 120 in FIG. 1 is illustrated as including an authentication engine 122, an automatic speech recognition (ASR) engine 124, a natural language understanding (NLU) engine 126, a fulfillment engine 128, a contextual values engine 130, a state adaptation engine 132, a feedback engine 134, an invocation hot word engine 136, an action hot word engine 138, and an invocation-free engine 140. In some implementations, one or more of the illustrated engines can be omitted from the automated assistant client 120. For example, engine(s) can instead be implemented only by cloud-based automated assistant component(s) 180 or can be omitted from the automated assistant client 120 and from the cloud-based automated assistant component(s) 180. Additionally, in some implementations, additional engine(s) can be provided on automated assistant client 120, such as a text-to-speech (TTS) engine, a voice activity detector (VAD) engine, an endpoint detector engine, and/or other engine(s).

The authentication engine 122 can determine whether user(s), present in an environment of the assistant device 110, are registered user(s) and/or guest user(s), and can optionally determine that a user is a particular registered user. The authentication engine 122 can utilize, for example, text-dependent speaker identification (TDSID) techniques, text-independent speaker identification (TISID) techniques, facial verification techniques, and/or other verification technique(s) (e.g., PIN entry) in determining whether a given user is a registered user or a non-registered guest user. Verification feature(s) can be generated and stored for each of the registered users of the assistant device 110 (e.g., stored locally at the assistant device 110 in association with their corresponding user accounts), with permission from the associated registered user(s). The authentication engine 122 can compare current sensor-based feature(s) to stored verification feature(s) to determine whether there is a match. If there is a match, the authentication engine 122 can determine that the corresponding registered user is present in the environment of the assistant device 110.

In some implementations, the authentication engine 122 utilizes one or more local authentication machine learning model(s) 142 in generating the current sensor-based feature(s). As one example, audio data determined to capture an invocation hot word can be processed using a TDSID model, of the local authentication machine learning model(s) 142, to generate a current TDSID embedding. Further, the current TDSID embedding can be compared to user TDSID embedding(s), each stored in association with a corresponding user account, to determine if there is a match (e.g., a distance between the current TDSID embedding and a user TDSID embedding is less than a threshold). If so, the authentication engine 122 can determine that the hot word was spoken by the matching registered user. As another example, audio data capturing a spoken utterance can be processed using a TISID model, of the local authentication machine learning model(s) 142, to generate a current TISID embedding. Further, the current TISID embedding can be compared to user TISID embedding(s), each stored in association with a corresponding user account, to determine if there is a match (e.g., a distance between the current TISID embedding and a user TISID embedding is less than a threshold). If so, the authentication engine 122 can determine the spoken utterance was spoken by the matching registered user. As yet another example, vision data capturing a user’s face can be processed using a facial verification model, of the local authentication machine learning model(s) 142, to generate a current facial embedding. Further, the current facial embedding can be compared to user facial embedding(s), each stored in association with a corresponding user account, to determine if there is a match (e.g., a distance between the current facial embedding and a user facial embedding is less than a threshold). If so, the authentication engine 122 can determine the registered user is present in the environment of the assistant device 110.

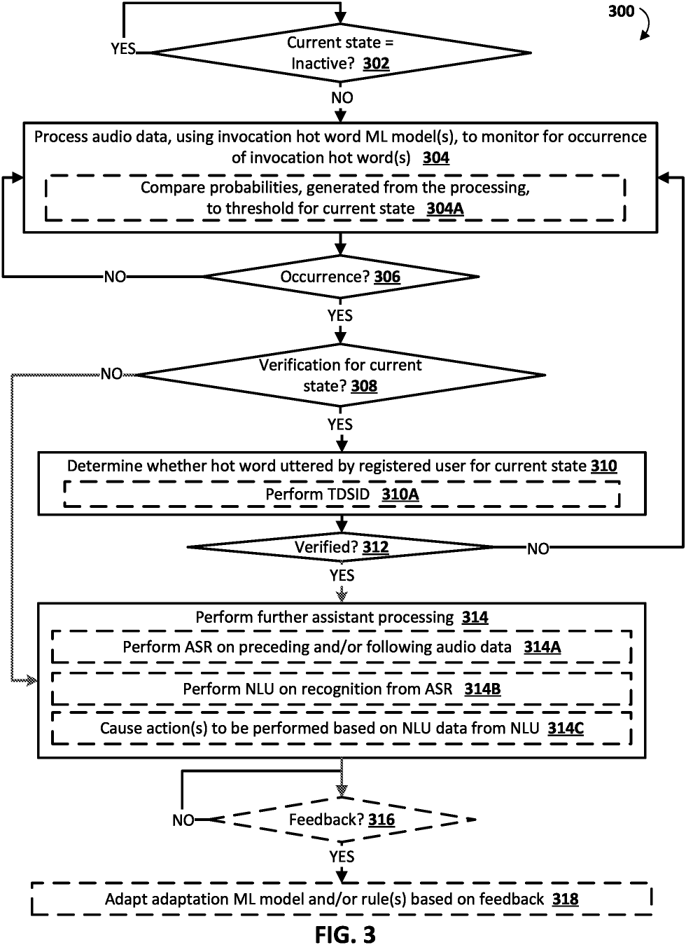

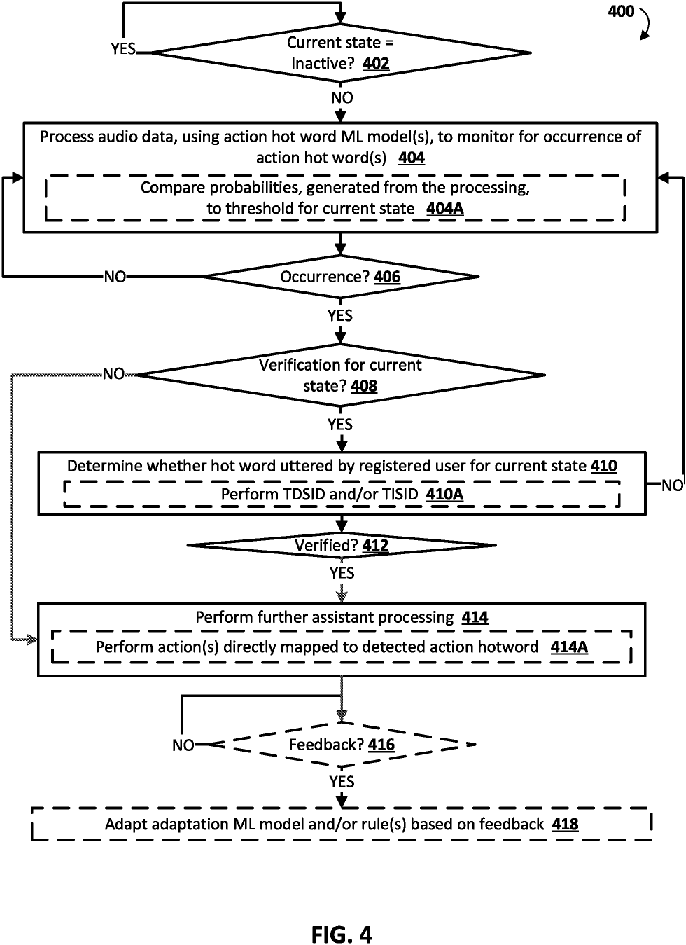

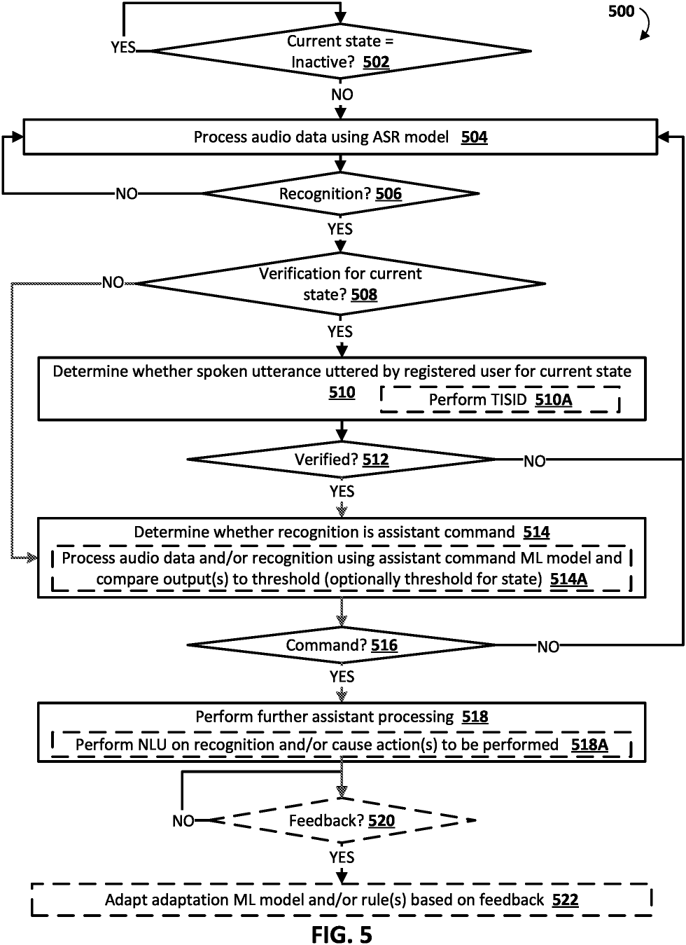

In some implementations, the authentication engine 122 can be used in determining whether a spoken utterance is from a registered user (a general determination, or determining whether from a particular registered user) in at least some state(s) of audio data based processing. For example, the authentication engine 122 can perform block 310A of method 300 of FIG. 3, block 410A of method 400 of FIG. 4, and/or block 510A of method 500 of FIG. 5. In some additional or alternative implementations, the authentication engine 122 can be used in generating registered user value(s) for registered user parameter(s) of contextual parameter(s) described herein. For example, the authentication engine 122 can process audio data from microphone(s) 111 and/or vision component(s) 113 in generating value(s) that indicate whether one or more registered users are present in an environment of the assistant device and/or can indicate which of the one or more registered users are present in the environment.

The ASR engine 124 can process audio data that captures a spoken utterance to generate a recognition of the spoken utterance. For example, the ASR engine 124 can process the audio data utilizing local ASR machine learning model(s) 144 to generate a prediction of recognized text that corresponds to the utterance.

The NLU engine 126 can process audio data and/or a recognition generated from audio data by the ASR engine 124, and generate NLU data based on the processing. The NLU data can reflect semantic meaning(s) of a corresponding spoken utterance. For example, the NLU data can include intent(s) and parameter(s) for the intent(s). The NLU engine 126 can further optionally determine assistant action(s) that correspond to those semantic meaning(s). In some implementations, the NLU engine 126 determines assistant action(s) as intent(s) and/or parameter(s) that are determined based on recognition(s) of the ASR engine 124. In some situations, the NLU engine 126 can resolve the intent(s) and/or parameter(s) based on a single utterance of a user and, in other situations, prompts can be generated based on unresolved intent(s) and/or parameter(s), those prompts rendered to the user, and user response(s) to those prompt(s) utilized by the NLU engine 126 in resolving intent(s) and/or parameter(s). In those situations, the NLU engine 126 can optionally work in concert with a dialog manager engine (not illustrated) that determines unresolved intent(s) and/or parameter(s) and/or generates corresponding prompt(s). The NLU engine 126 can utilize local NLU machine learning model(s) 146 in generating NLU data and/or in determining assistant action(s).

The fulfillment engine 128 can cause performance of assistant action(s) that are determined by the NLU engine 126. For example, if the NLU engine 126 determines an assistant action of “turning on the kitchen lights”, the fulfillment engine 128 can cause transmission of corresponding data (directly to the lights or to a remote server associated with a manufacturer of the lights) to cause the “kitchen lights” to be “turned on”. As another example, if the NLU engine 126 determines an assistant action of “provide a summary of the user’s meetings for today”, the fulfillment engine 128 can access the user’s calendar, summarize the user’s meetings for the day, and cause the summary to be visually (via display(s) 114) and/or audibly (via speaker(s) 112) rendered at the assistant device 110.

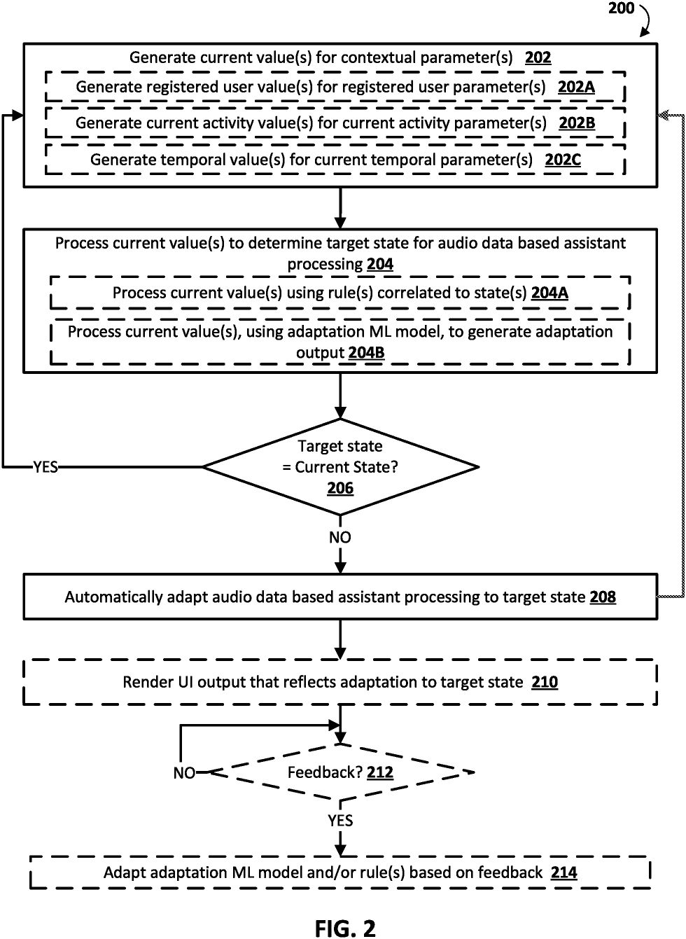

The contextual values engine 130 at least intermittently generates current value(s), for dynamic contextual parameter(s), and provides the current value(s) for use by state adaptation engine 132. In some implementations, the contextual values engine 130 performs block 202 of method 200 of FIG. 2. In generating one or more of the current value(s), the contextual values engine 130 can optionally utilize one or more local contextual machine learning model(s) 150. In some implementations, the contextual values engine 130 generates current value(s) for registered user parameter(s), current activity parameter(s), and/or temporal parameter(s).

When the contextual values engine 130 generates registered user value(s) for registered user parameter(s), they can indicate whether one or more registered users are present in an environment of the assistant device and/or can indicate which of the one or more registered users are present in the environment. In generating registered user value(s), the contextual values engine 130 can interface with the authentication engine 122 in determining whether and/or which registered user(s) are currently present in an environment of the assistant device 110. For example, the authentication engine 122 can perform TISID, locally at the assistant device 110, to determine whether and/or which registered user(s) are currently present near the assistant device. Corresponding data can be utilized, by the contextual values engine 130, to generate registered user value(s) that reflect whether and/or which registered user(s) are currently present.

When the contextual values engine 130 generates current activity value(s) for current activity parameter(s), they can indicate whether one or more activities are occurring in the environment and/or can indicate which of the one or more activities are occurring in the environment. For example, a locally stored calendar entry of a registered user can be accessed, by the contextual values engine 130, to determine whether the user is in a meeting, and the contextual values engine 130 can generate a current activity value that reflects whether the user is in the meeting. For example, the current activity value can reflect generally that a registered user is engaged in an activity or, more particularly, that the user is in a meeting and/or one or more properties of the meeting. As another example, the contextual values engine can access activity data, corresponding to application(s) running on the assistant device 110 and/or of other client device(s) in the environment, and the contextual values engine 130 can generate a current activity value that reflects one or more activities being performed via the application(s). For instance, contextual values engine 130 can generate a current activity value, that reflects the user is in a meeting, based on activity data that is from a separate tablet computer and that corresponds to a video application of the tablet computer. The activity data can be provided by the video application or by an operating system of the tablet computer.

As yet another example, the contextual values engine 130 can process, using one or more of the local contextual machine learning model(s) 150, a stream of audio data from microphone(s) 111, to monitor for occurrence of one or more type(s) of sound(s). The contextual values engine 130 can generate current activity value(s) that indicate, directly or indirectly, whether certain type(s) of sound(s) are currently detected. For example, in response to recent (e.g., within the last 5 seconds, 10 seconds, or other threshold) detection of a type of sound, the contextual values engine 130 can generate current activity value(s) that generally indicate that an activity is occurring or, more particularly, reflect a particular activity corresponding to the type of sound. For example, an “eating” activity can be inferred based on local processing of a stream of audio data indicating the presence of cutlery sounds, and the current activity value can reflect the particular eating activity. As another example, a “listening to music” activity can be inferred based on local processing of a stream of audio data indicating the presence of music, and the current activity value can reflect the particular listening to music activity. As another example, a “phone ringing” activity can be inferred based on local processing of a stream of audio data indicating the presence of a phone ringing, and the current activity value can reflect the particular phone ringing activity. As yet another example, a “doorbell ringing” activity can be inferred based on local processing of a stream of audio data indicating the presence of a doorbell ringing, and the current activity value can reflect the particular doorbell ringing activity.

When the contextual values engine 130 generates current temporal value(s) for temporal parameter(s), they can indicate one or more current temporal conditions such as time of day (e.g., specific such as 9:00am or general such as morning), a day of the week (e.g., Monday, Tuesday, etc.), a day of the year (e.g., 23^{rd} of December), or month.

The state adaptation engine 132 at least intermittently processes current values, for contextual parameters and that are generated by the contextual values engine 130, to determine whether to automatically adapt a current state of audio data based assistant processing to a different state. In some implementations, the state adaptation engine 132 performs blocks 204, 206, and/or 208 of method 200 of FIG. 2.

The state adaptation engine 132 can determine to automatically adapt the audio data based assistant processing from a current state to an alternate state in response to the processing satisfying one or more conditions. For example, the state adaptation engine 132 can process current values for the dynamic contextual parameters using one or more trained adaptation machine learning models 152 to generate output that indicates which, of two or more states, should be active in view of the current values. In such an example, satisfaction of the condition(s) can include that the output indicates that the alternate state should be active in lieu of the currently active current state. Also, for example, state adaptation engine 132 can additionally or alternatively process the current values for the dynamic contextual parameters using one or more rules that are each for a corresponding state, to determine whether the rule is satisfied. In such an example, satisfaction of the condition(s) can include the processing indicating that a rule, for the alternate state, is satisfied. In response to satisfaction of the condition(s), the state adaptation engine 132 can direct one or more corresponding engines to automatically adapt their audio data based processing from a current state to the alternate state. For example, the state adaptation engine 132 can direct the invocation hot word engine to transition from a currently active first threshold state to an alternate second threshold state. As another example, the state adaptation engine 132 can direct the invocation-free engine 140 to transition from a currently active fully active state to an alternate partially active state.

In some implementations, the state adaptation engine 132 can, in response to adapting the processing to the alternate state, cause user interface output(s) to be rendered that reflect the alternate state to which the audio data based processing was adapted. For example, a chime corresponding to the alternate state can be audibly rendered via the speaker(s) 112 upon adaptation and/or graphical elements corresponding to the alternate state can be visually rendered via the display(s) 114. The rendering of one or more of the user interface output(s) can optionally be persistent throughout the duration of the alternate state, then replaced with alternate user interface output(s) responsive to adaptation to a different state.

The feedback engine 134 can utilize user feedback, received via assistant device 110, to: selectively alter an adaptation made by state adaptation engine 132; train machine learning model(s) utilized by state adaptation engine 132; and/or to alter rule(s) utilized by state adaptation engine 132. For example, in response to an adaptation that state adaptation engine 132 caused to be implemented, further user interface input can be provided, by a user, to provide feedback on the adaptation. The feedback can be, for example, feedback that the adaptation was correct, feedback that an alternate adaptation should have been made, or feedback that no adaptation should have been made. For example, the feedback can be via spoken input and/or via interaction with graphical interface element(s) that facilitate the feedback. The feedback engine 134 can utilize the feedback to adapt (e.g., for at least the assistant device 110), the adaptation machine learning model(s) 152 and/or rule(s) on which the adaptation was based. For example, the feedback can indicate that a rule, upon which the adaptation was based, should be deleted or modified. In response, the feedback engine 134 can delete or modify the rule accordingly.

As another example, the adaptation may have been to a first state based on the state adaptation engine 136 processing, using one of the machine learning model(s) 152, current contextual values and generating a first output that indicated a highest probability for the first state. The feedback can indicate that a second state should be utilized instead of the first state. In response, the feedback engine 134 can generate a training example that includes the processed current contextual values as input and, as output, alternate output that indicates a highest probability for the second state. The feedback engine 134 can train the one of the adaptation machine learning model(s) 152 based on the generated training example. Additionally or alternatively, when the feedback indicates that no adaptation or an alternate adaptation should have been made, feedback engine 134 can use the feedback to further immediately adapt the audio data based processing to the prior current state or to another alternate state.

In some implementations, the feedback engine 134 performs blocks 212 and/or 214 of method 200 of FIG. 2, blocks 316 and/or 318 of method 300 of FIG. 3, blocks 416 and/or 418 of method 400 of FIG. 4, and/or blocks 520 and/or 522 of method 500 of FIG. 5.

The invocation hot word engine 136 can cause further assistant processing to be performed in response to detection of an invocation hot word. For example, the invocation hot word engine 136 can invoke the automated assistant 100 in response to detecting any of one or more spoken invocation hot words such as “Hey Assistant,” “OK Assistant”, and/or “Assistant”. The invocation hot word engine 136 can continuously process (e.g., if not in an “inactive” state) a stream of audio data that is based on output from one or more of the microphone(s) 111 of the assistant device 110, to monitor for an occurrence of an invocation hot word. The processing can be utilizing one or more invocation hot word machine learning model(s) 156. While monitoring for the occurrence of the spoken invocation phrase, the invocation hot word engine 136 discards (e.g., after temporary storage in a buffer) any audio data that does not include the invocation hot word. However, when the invocation hot word engine 136 detects an occurrence of an invocation hot word in processed audio data, the invocation hot word engine 136 can at least selectively cause further assistant processing to be performed. The further assistant processing can include, for example, automatic speech recognition (ASR) (e.g., by ASR engine 124 and/or cloud-based ASR engine 184) to generate a recognition of a spoken utterance that precedes and/or follows the invocation hot word, NLU (e.g., by NLU engine 126 and/or cloud-based NLU engine 186) based on the recognition, and/or fulfillment (e.g., by fulfillment engine 128 and/or cloud-based fulfillment engine 188) based on NLU data generated based on performing the NLU.

In some implementations, in determining whether an invocation hot word is present in processed audio data, the invocation hot word engine 136 can compare output generated from processing the audio data to threshold(s). Further, in some of those implementations, the threshold(s) utilized can be dependent on the currently active state as dictated by the state adaptation engine 132. In some additional or alternative implementations, in determining whether to perform the further assistant processing, the invocation hot word engine 136 can make the determination further based on whether the invocation hot word and/or the spoken utterance is from a registered user (a particular registered user or any registered user). Further, in some of those implementations, whether the determination is further based on whether the invocation hot word and/or the spoken utterance is from a registered user can be dependent on the currently active state as dictated by the state adaptation engine 132.

In some implementations, invocation hot word engine 136 performs blocks 302, 304, 306, 308, and/or 310 of method 300 of FIG. 3.

The action hot word engine 138 can cause a particular action to be invoked, via the automated assistant 100, in response to detection of a spoken action hot word. For example, the action hot word engine 138 can cause a “play music” action to be directly invoked in response to detecting a “play music” action hotword and/or “jam out” action hot word. The action hot word engine 138 can continuously process (e.g., if not in an “inactive” state) a stream of audio data that is based on output from one or more of the microphone(s) 111 of the assistant device 110, to monitor for an occurrence of an action hot word. The processing can be utilizing one or more action hot word machine learning model(s) 158. While monitoring for the occurrence of the action hot word, the action hot word engine 138 discards (e.g., after temporary storage in a buffer) any audio data that does not include the spoken invocation phrase. However, when the action hot word engine 138 detects an occurrence of an action hot word in processed audio data, the action hot word engine 138 can at least selectively cause the action to be invoked.

In some implementations, in determining whether an action hot word is present in processed audio data, the action hot word engine 138 can compare output generated from processing the audio data to threshold(s). Further, in some of those implementations, the threshold(s) utilized can be dependent on the currently active state as dictated by the state adaptation engine 132. In some additional or alternative implementations, in determining whether to invoke the action, the action hot word engine 138 can make the determination further based on whether the action hot word is from a registered user (a particular registered user or any registered user). Further, in some of those implementations, whether the determination is further based on whether the action hot word is from a registered user can be dependent on the currently active state as dictated by the state adaptation engine 132.

In some implementations, action hot word engine 138 performs blocks 402, 404, 406, 408, and/or 410 of method 400 of FIG. 4.

The invocation-free engine 140 can (e.g., if not in an “inactive” state) cause ASR engine 124 to perform ASR processing on audio data, that is based on output from one or more of the microphone(s) 111 of the assistant device 110, to generate a recognition of a spoken utterance captured in the audio data. Further, the invocation-free engine 140 can process the recognition and/or the audio data, using invocation-free model(s) 160, to generate output(s) that indicate whether the spoken utterance is an assistant command. When the output(s) indicate the spoken utterance is not an assistant command, the invocation-free engine 140 can discard the audio data and the recognition. However, when the output(s) indicate the spoken utterance is an assistant command, the invocation-free engine 140 can cause further assistant processing to be performed. For example, the further assistant processing can include performing NLU based on the recognition and/or performing fulfillment based on NLU data from the NLU.

In some implementations, in determining whether the spoken utterance is an assistant command, the invocation-free engine 140 can compare output(s) generated from processing the recognition and/or the audio data to threshold(s). Further, in some of those implementations, the threshold(s) utilized can be dependent on the currently active state as dictated by the state adaptation engine 132. In some additional or alternative implementations, in determining whether the spoken utterance is an assistant command, the invocation-free engine 140 can make the determination further based on whether the spoken utterance is from a registered user (a particular registered user or any registered user). Further, in some of those implementations, whether the determination is further based on whether the spoken utterance is from a registered user can be dependent on the currently active state as dictated by the state adaptation engine 132.

In some implementations, invocation-free engine 140 performs blocks 502, 506, 508, 510, 512, 514, 516, and/or 518 of method 500 of FIG. 5.

In various implementations, the assistant device 110 may optionally operate one or more other applications that are in addition to automated assistant client 120, such as a message exchange client (e.g., SMS, MMS, online chat), a browser, and so forth. In some of those various implementations, one or more of the other applications can optionally interface (e.g., via an application programming interface) with the automated assistant 100, or include their own instance of an automated assistant application (that may also interface with the cloud-based automated assistant component(s) 180).

Cloud-based automated assistant component(s) 180 are optional and can operate in concert with corresponding component(s) of the assistant client 120 and/or can be utilized (always or selectively) in lieu of corresponding component(s) of the assistant client 120. In some implementations, cloud-based component(s) 180 can leverage the virtually limitless resources of the cloud to perform more robust and/or more accurate processing of audio data, and/or other data, relative to any counterparts of the automated assistant client 120. In various implementations, the assistant device 110 can provide audio data and/or other data to the cloud-based automated assistant components 180 in response to a hot word engine detecting a hot word, or detecting some other explicit invocation of the automated assistant 100.

The illustrated cloud-based automated assistant components 180 include a cloud-based ASR engine 182, a cloud-based NLU engine 186, and a cloud-based fulfillment engine 148. These components can perform similar functionality to their automated assistant counterparts (if any). In some implementations, one or more of the illustrated cloud-based engines can be omitted (e.g., instead implemented only by automated assistant client 120) and/or additional cloud-based engines can be provided (e.g., a cloud-based authentication engine counterpart and/or invocation-free engine counterpart).

FIG. 2 is a flowchart illustrating an example method 200 of automatically adapting audio data based assistant processing in dependence on contextual parameters. For convenience, the operations of the flow chart are described with reference to a system that performs the operations. This system may include various components of various computer systems, such as one or more components of automated assistant client 120. Moreover, while operations of method 200 are shown in a particular order, this is not meant to be limiting. One or more operations may be reordered, omitted or added.

At block 202, the system generates current value(s) for contextual parameter(s). One or more of the current value(s) can be generated based on sensor-based observation(s) from sensor(s) of an assistant device and/or based on data that is locally available at the assistant device. Block 202 optionally includes blocks 202A, 202B, and/or 202C.

At block 202A, the system generates registered user value(s), of the current value(s), for registered user parameter(s) of the contextual parameter(s). The registered user value(s) can indicate whether one or more registered users are present in an environment of the assistant device and/or can indicate which of the one or more registered users are present in the environment. In some implementations, the system interfaces with an authentication engine in generating the registered user values.

At block 202B, the system generates current activity value(s), of the current value(s), for current activity parameter(s) of the contextual parameter(s). The current activity value(s) can indicate whether one or more activities are occurring in the environment and/or can indicate which of the one or more activities are occurring in the environment.

At block 202C, the system generates temporal value(s), of the current value(s), for current temporal parameter(s) of the contextual parameter(s).

At block 204, the system processes the current value(s), generated at a most recent iteration of block 202, to determine a target state for audio data based assistant processing. The audio data based assistant processing can be, for example, hot word processing (invocation and/or action hot word processing) and/or invocation-free hot word processing. In some implementations, the system processes the current value(s) to generate output(s) and determines the target state based on which condition(s) are satisfied by the output(s). For example, a first state can be correlated to first output(s), a second state correlated to second output(s), a third state correlated to third output(s), etc. In some implementations, block 204 optionally includes blocks 204A and/or 204B. In some of those implementations, block 204A is performed and, if condition(s) aren’t satisfied by block 204A, then block 204B is performed.

At block 204A, the system processes the current value(s) using rule(s) that are correlated to state(s). For example, a first rule can be correlated to a first state, a second rule can be correlated to a second state, a third rule can be correlated to the first state, etc. At block 204A, the system can determine that a given state is the target state responsive to determining that a rule, correlated to the given state, is satisfied. Determining that the rule is satisfied can include applying the current value(s) to the rule. Determining a condition for the given state is satisfied can include determining that the rule, correlated to the given state, is satisfied. In situations where multiple rules, with conflicting correlated states, are satisfied, one or more techniques can be utilized to select one rule (and its corresponding correlated state) over the other satisfied rules. For example, the system can select the most recently created of the rules or can select the most specific of the rules (e.g., that having values or value ranges for the largest quantity of contextual parameters).

At block 204B, the system processes current value(s), using an adaptation ML model, to generate adaptation output. At block 204B, the system can determine a given state is the target state responsive to the adaptation output being correlated with the given state. For example, the output can indicate which, of two or more states, should be active in view of the current values. Determining a condition for the given state is satisfied can include determining that the output indicates the given state should be active.

At block 206, the system determines whether the target state, generated at a most recent iteration of block 204, is the same as the current state that is currently active at the assistant device. In some situations, the current state that is currently active can be one that was most recently automatically adapted at a most recent iteration of block 208 (described below). In some other situations, the current state that is currently active can be one that was manually set by a user of the assistant device by providing one or more explicit user interface inputs at the assistant device.

If, at block 206, the system determines the target state is the same as the current state, the system returns to block 202 to perform another iteration of blocks 202, 204, and 206. In some implementations, the system returns immediately to block 202. In some other implementations, the system pauses for a fixed or dynamic threshold amount of time (e.g., 5 seconds, 30 seconds, or 1 minute) before returning to block 202 and/or awaiting occurrence of other condition(s) before returning to block 202. For example, the other condition(s) can be detecting voice activity, detecting presence via a passive presence detector of the assistant device, and/or detecting presence based on image(s) from a camera of the assistant device.

If, at block 206, the system determines the target state is not the same as the current state, the system proceeds to block 208 and automatically adapts the audio data based assistant processing from the current state to the target state. The system then returns to block 202 to perform another iteration of blocks 202, 204, and 206. In some implementations, the system returns immediately to block 202. In some other implementations, the system pauses for a fixed or dynamic threshold amount of time (e.g., 5 seconds, 30 seconds, or 1 minute) before returning to block 202 and/or awaiting occurrence of other condition(s) before returning to block 202.

Upon performance of an iteration of block 208, the system optionally proceeds to optional block 210. At block 210, the system renders UI output that reflects the adaptation, to the target state, from the most recent iteration of block 208. For example, the UI output can include text that describes the target state and/or graphical symbol(s) that are correlated with the target state (and that differ from graphical symbol(s) for other state(s)).

At optional block 212, the system determines whether feedback, from a user of the assistant device, is received. For example, the feedback can be user interface input received responsive to the optional rendering at block 210. For instance, the rendering at block 210 can further include visually rendering selectable alternate graphical element(s) that each reflect a corresponding alternate state that is not the target state. In such an instance, the feedback can be a user selection of one of the alternate graphical element(s), and can be negative feedback that indicates that the corresponding alternate state should have been implemented in lieu of the target state. As another instance, the feedback can be proactive feedback of the user. For example, the proactive feedback can be negative feedback of the user providing spoken input that indicates an alternate state and/or can be the user manually adapting to the alternate state within a threshold duration of time of the automatic adaptation of the most recent iteration of block 208. As yet another instance, the feedback can be positive feedback of the user confirming that the target state is a desired state. For instance, a confirmation selectable graphical element, for the target state, can be visually rendered and selection of the confirmation selectable graphical element can indicate that the target state is correct for the current contextual values. If no feedback is received at block 212, the system can return to block 212 and continue to monitor for feedback – for at least a threshold duration of time.

If feedback is received at optional block 212, the system can proceed to optional block 214. At optional block 214, the system can use the feedback in adapting an adaptation ML model and/or rule(s), utilized at a most recent iteration of block 204. Optionally, if the feedback is negative feedback that indicates an alternate state, the system can additionally or alternatively immediately adapt the audio data based processing to the alternate state.

As one example of block 214, the system can generate a supervised training example based on the feedback, and use the training example to further train the adaptation ML model. As another example of block 214, the system can use the feedback to delete or adapt a rule that was utilized in determining the target state in a most recent iteration of block 204.

FIG. 3 is a flowchart illustrating an example method 300 of performing invocation hot word processing in dependence on a currently active state. The currently active state at any given time can be based on, for example, a most recent adaptation from block 208 of method 200 of FIG. 2.

For convenience, the operations of the flow chart are described with reference to a system that performs the operations. This system may include various components of various computer systems, such as one or more components of automated assistant client 120. Moreover, while operations of method 300 are shown in a particular order, this is not meant to be limiting. One or more operations may be reordered, omitted or added.

At block 302, the system determines whether the current state, for invocation hot word processing, is an inactive state. If so, the system performs another iteration of block 302. If not, the system proceeds to block 304. The system can return to block 302 at any time responsive to the current state being adapted again to the inactive state.

At block 304, the system processes audio data, using invocation hot word ML model(s), to monitor for occurrence of invocation hot word(s). Block 304 optionally includes block 304A, in which the system, in monitoring for the occurrence, compares one or more probabilities, generated from the processing, to a threshold for the current state. For example, if the currently active state specifies a particular threshold, that particular threshold can be utilized in determining whether the hot word occurs. For instance, a first state can specify a first more permissive threshold and a second state can specify a second more restrictive threshold.

At block 306, the system determines whether there is an occurrence of an invocation hot word. If not, the system returns to block 304. If so, the system proceeds to block 308.

At block 308, the system determines whether verification is required for the current state. For example, if the currently active state specifies that invocation hot word processing is active for only registered users, or only particular registered user(s), then the system can determine that verification is required for the current state. On the other hand, if the currently active state specifies that invocation hot word processing is fully active, then the system can determine that verification is not required for the current state.

If, at block 308, the system determines verification is not required for the current state, the system proceeds to block 314 and performs further assistant processing. If, at block 308, the system determines verification is required for the current state, the system proceeds to block 310.

At block 310, the system determines whether the hot word was uttered by a registered user for the current state. In some implementations, block 310 includes block 310A in which the system performs TDSID, on the portion of the audio data that corresponds to the hot word, to determine whether a registered user for the current state (i.e., hot word processing is active for the registered user for the current state) uttered the hot word. In some implementations, at block 310 the system can additionally or alternatively perform TISID (e.g., on audio data that captures the hot word and/or one preceding and/or following audio data) and/or facial verification (e.g., based on image(s) that capture a speaking user) in determining whether the hot word was uttered by a registered user for the current state.

At block 312, the system determines whether the determination at block 310 indicates the hot word was verified as being uttered by a registered user verified for the current state. If, at block 312, the system determines the hot word was not uttered by a registered user for the current state (e.g., was instead uttered by a guest user), the system returns to block 304, thereby suppressing any further assistant processing of block 314.

If, at block 312, the system determines the hot word was uttered by a registered user for the current state, the system proceeds to block 314 and performs further assistant processing.

Block 314 optionally includes block 314A, block 314B, and/or block 314C.

At block 314A, the system performs ASR on audio data that precedes the hot word and/or that follows the hot word. Performing the ASR can result in recognition of a spoken utterance captured in the audio data, where the spoken utterance is in addition to the hot word.

At block 314B, the system performs NLU on recognition from ASR, such as ASR performed in block 314A or performed prior to block 314 (e.g., when performance of 314A is not selectively suppressed). The system generates NLU data based on performing the NLU.

At block 314C, the system causes action(s) to be performed based on the NLU data from the NLU, such as NLU performed in block 314B or performed prior to block 314 (e.g., when performance of block 314B is not selectively suppressed).

At optional block 316, the system determines whether user feedback is received that indicates the current state was correct and/or is incorrect. For example, if the user has a positive response to and/or further engages with action(s) performed from the further assistant processing of block 314, this can indicate that the current state was correct (i.e., the invocation hot word processing was intended to be performed). On the other hand, if the user has a negative response to and/or halts the further assistant processing of block 314 through intervening user interface input (e.g., speaking “cancel” or selecting a “cancel” user interface element), this can indicate that the current state was incorrect (i.e., the invocation hot word processing was not intended to be performed).

If no feedback is received at block 316, the system can return to block 316 and continue to monitor for feedback – for at least a threshold duration of time.

If feedback is received at optional block 316, the system can proceed to optional block 318. At optional block 318, the system can use the feedback in adapting an adaptation ML model and/or rule(s), utilized at a most recent iteration of block 204 (method 200 of FIG. 2) that resulted in the current state. Optionally, if the feedback is negative feedback that indicates an alternate state, the system can additionally or alternatively immediately adapt the audio data based processing to the alternate state. As one example of block 318, the system can generate a supervised training example based on the feedback, and use the training example to further train the adaptation ML model. As another example of block 318, the system can use the feedback to delete or adapt a rule that was utilized in determining the target state in a most recent iteration of block 204.

FIG. 4 is a flowchart illustrating an example method 400 of performing action hot word processing in dependence on a currently active state. The currently active state at any given time can be based on, for example, a most recent adaptation from block 208 of method 200 of FIG. 2.

For convenience, the operations of the flow chart are described with reference to a system that performs the operations. This system may include various components of various computer systems, such as one or more components of automated assistant client 120. Moreover, while operations of method 400 are shown in a particular order, this is not meant to be limiting. One or more operations may be reordered, omitted or added.

At block 402, the system determines whether the current state, for invocation hot word processing, is an inactive state. If so, the system performs another iteration of block 402. If not, the system proceeds to block 404. The system can return to block 402 at any time responsive to the current state being adapted again to the inactive state.

At block 404, the system processes audio data, using action hot word ML model(s), to monitor for occurrence of action hot word(s). Block 404 optionally includes block 404A, in which the system, in monitoring for the occurrence, compares one or more probabilities, generated from the processing, to a threshold for the current state. For example, if the currently active state specifies a particular threshold, that particular threshold can be utilized in determining whether the action hot word occurs. For instance, a first state can specify a first more permissive threshold and a second state can specify a second more restrictive threshold.

At block 406, the system determines whether there is an occurrence of an action hot word. If not, the system returns to block 404. If so, the system proceeds to block 408.

At block 408, the system determines whether verification is required for the current state. For example, if the currently active state specifies that invocation hot word processing is active for only registered users, or only particular registered user(s), then the system can determine that verification is required for the current state. On the other hand, if the currently active state specifies that invocation hot word processing is fully active, then the system can determine that verification is not required for the current state.

If, at block 408, the system determines verification is not required for the current state, the system proceeds to block 414 and performs further assistant processing. If, at block 408, the system determines verification is required for the current state, the system proceeds to block 410.

At block 410, the system determines whether the hot word was uttered by a registered user for the current state. In some implementations, block 410 includes block 410A in which the system performs TDSID and/or TISID, on the portion of the audio data that corresponds to the action hot word, to determine whether a registered user for the current state (i.e., hot word processing is active for the registered user for the current state) uttered the action hot word. In some implementations, at block 410 the system can additionally or alternatively utilize facial verification (e.g., based on image(s) that capture a speaking user) in determining whether the action hot word was uttered by a registered user for the current state.

At block 412, the system determines whether the determination at block 410 indicates the action hot word was verified as being uttered by a registered user verified for the current state. If, at block 412, the system determines the hot word was not uttered by a registered user for the current state (e.g., was instead uttered by a guest user), the system returns to block 404, thereby suppressing any further assistant processing of block 414.

If, at block 412, the system determines the hot word was uttered by a registered user for the current state, the system proceeds to block 414 and performs further assistant processing.

Block 414 optionally includes block 414A, in which the system performs action(s) that are directly mapped to the detected action hot word. For example, if the action hot word is “play music” the action(s) can include causing locally stored music to be played or causing a streaming music session to be initiated with a remote music streaming service.

At optional block 416, the system determines whether user feedback is received that indicates the current state was correct and/or is incorrect. For example, if the user has a positive response to and/or further engages with action(s) performed from the further assistant processing of block 414, this can indicate that the current state was correct (i.e., the invocation hot word processing was intended to be performed). On the other hand, if the user has a negative response to and/or halts the further assistant processing of block 414 through intervening user interface input (e.g., speaking “cancel” or selecting a “cancel” user interface element), this can indicate that the current state was incorrect (i.e., the invocation hot word processing was not intended to be performed).

If no feedback is received at block 416, the system can return to block 416 and continue to monitor for feedback – for at least a threshold duration of time.

If feedback is received at optional block 416, the system can proceed to optional block 418. At optional block 418, the system can use the feedback in adapting an adaptation ML model and/or rule(s), utilized at a most recent iteration of block 204 (method 200 of FIG. 2) that resulted in the current state. Optionally, if the feedback is negative feedback that indicates an alternate state, the system can additionally or alternatively immediately adapt the audio data based processing to the alternate state. As one example of block 418, the system can generate a supervised training example based on the feedback, and use the training example to further train the adaptation ML model. As another example of block 418, the system can use the feedback to delete or adapt a rule that was utilized in determining the target state in a most recent iteration of block 204.

FIG. 5 is a flowchart illustrating an example method 500 of performing invocation-free speech processing in dependence on a currently active state. The currently active state at any given time can be based on, for example, a most recent adaptation from block 208 of method 200 of FIG. 2.

For convenience, the operations of the flow chart are described with reference to a system that performs the operations. This system may include various components of various computer systems, such as one or more components of automated assistant client 120. Moreover, while operations of method 500 are shown in a particular order, this is not meant to be limiting. One or more operations may be reordered, omitted or added.

At block 502, the system determines whether the current state, for invocation hot word processing, is an inactive state. If so, the system performs another iteration of block 502. If not, the system proceeds to block 504. The system can return to block 502 at any time responsive to the current state being adapted again to the inactive state.

At block 504, the system processes audio data, using an ASR model that is local to the assistant device, in attempting to generate recognition results for any spoken utterance captured in the audio data. In some implementations the system performs block 504 continuously. In other implementations, the system performs block 504 responsive to detecting voice activity (e.g., using a voice activity detector) and/or responsive to other condition(s) being satisfied.

At block 506, the system determines whether there is an ASR recognition from the processing of block 504. If not, the system returns to block 504. If so, the system proceeds to block 508.

At block 508, the system determines whether verification is required for the current state. For example, if the currently active state specifies that invocation-free processing is active for only registered users, or only particular registered user(s), then the system can determine that verification is required for the current state. On the other hand, if the currently active state specifies that invocation-free processing is fully active, then the system can determine that verification is not required for the current state.

If, at block 508, the system determines verification is not required for the current state, the system proceeds to block 514. If, at block 508, the system determines verification is required for the current state, the system proceeds to block 510.

At block 510, the system determines whether the spoken utterance, corresponding to the recognition of a most recent iteration of block 506, was uttered by a registered user for the current state. In some implementations, block 510 includes block 510A in which the system performs TISID, on the portion of the audio data that corresponds to the spoken utterance, to determine whether a registered user for the current state (i.e., hot word processing is active for the registered user for the current state) uttered the spoken utterance. In some implementations, at block 510 the system can additionally or alternatively utilize facial verification (e.g., based on image(s) that capture a speaking user) in determining whether the spoken utterance was uttered by a registered user for the current state.

At block 512, the system determines whether the determination at block 510 indicates the spoken utterance was verified as being uttered by a registered user verified for the current state. If, at block 512, the system determines the spoken utterance was not uttered by a registered user for the current state (e.g., was instead uttered by a guest user), the system returns to block 504, thereby suppressing any further assistant processing of block 518.

If, at block 512, the system determines the spoken utterance was uttered by a registered user for the current state, the system proceeds to block 514.

At block 514, the system determines whether the recognition, of a most recent iteration of block 506, is an assistant command. In some implementations, block 514 includes block 514A, in which the system processes, using an assistant command ML model, the audio data (corresponding to the spoken utterance), the recognition of the spoken utterance, and/or NLU data, to generate output(s). Further, the system compares the output(s) to a threshold in determining whether the recognition is an assistant command. For example, the assistant command ML model can be trained to process recognitions (e.g., a word embedding of the recognition) and features of the audio data to generate output that is a probability that indicates whether the recognition is an assistant command. That probability can be compared to the threshold. In some implementations, the threshold is a threshold that is particular to the current state. For example, if the currently active state specifies a particular threshold, that particular threshold can be utilized in determining whether the action hot word occurs. For instance, a first state can specify a first more permissive threshold and a second state can specify a second more restrictive threshold.

At block 516, the system determines whether the determination at block 514 indicates the recognition is an assistant command. If not, the system returns to block 504. If so, the system proceeds to block 518 and performs further assistant processing.

At block 518, the system performs further assistant processing. In some implementations, block 518 includes block 518A in which the system performs NLU on the recognition and/or causes actions to be performed (e.g., based on NLU data from the NLU of block 518A and/or previously performed NLU).

At optional block 520, the system determines whether user feedback is received that indicates the current state was correct and/or is incorrect. For example, if the user has a positive response to and/or further engages with action(s) performed from the further assistant processing of block 514, this can indicate that the current state was correct (i.e., the invocation-free processing was intended to be performed). On the other hand, if the user has a negative response to and/or halts the further assistant processing of block 414 through intervening user interface input (e.g., speaking “cancel” or selecting a “cancel” user interface element), this can indicate that the current state was incorrect (i.e., the invocation-free processing was not intended to be performed).

If no feedback is received at block 520, the system can return to block 416 and continue to monitor for feedback – for at least a threshold duration of time.

If feedback is received at optional block 520, the system can proceed to optional block 522. At optional block 418, the system can use the feedback in adapting an adaptation ML model and/or rule(s), utilized at a most recent iteration of block 204 (method 200 of FIG. 2) that resulted in the current state. Optionally, if the feedback is negative feedback that indicates an alternate state, the system can additionally or alternatively immediately adapt the audio data based processing to the alternate state.

It is noted that, in some implementations an assistant device performs only one of method 300, method 400, and method 500. In some other implementations, an assistant device can perform multiple of method 300, method 400, and method 500. In implementations where multiple of method 300, method 400, and method 500 are performed, they can all be based on the same instance of method 200 or, alternatively, one or more can be based on its own instance of method 200. For example, when based on the same instance of method 200 the same adaptations would be applied to each of the methods 300, 400, and 500. For example, if invocation hot word processing is in a first state then invocation-free processing would also be in the same first state. When one or more is based on its own instance of method 200, different adaptations would at least selectively be applied in different of the methods 300, 400, and 500. For example, a first instance of method 200 can utilize adaptation machine learning model(s) and/or rules that are specific to invocation hot word processing and can be used to adapt the state of invocation hot word processing (e.g., used to adapt only the state of invocation hot word processing). Further, a second instance of method 200 can utilize adaptation machine learning model(s) and/or rules that are specific to invocation-free processing and can be used to adapt the state of invocation-free processing (e.g., used to adapt only the state of invocation-free processing). Accordingly, in such situations invocation hot word processing can be in a first state (e.g., fully active state) and invocation-fee processing can at the same time be in a disparate second state (e.g., partially active state).

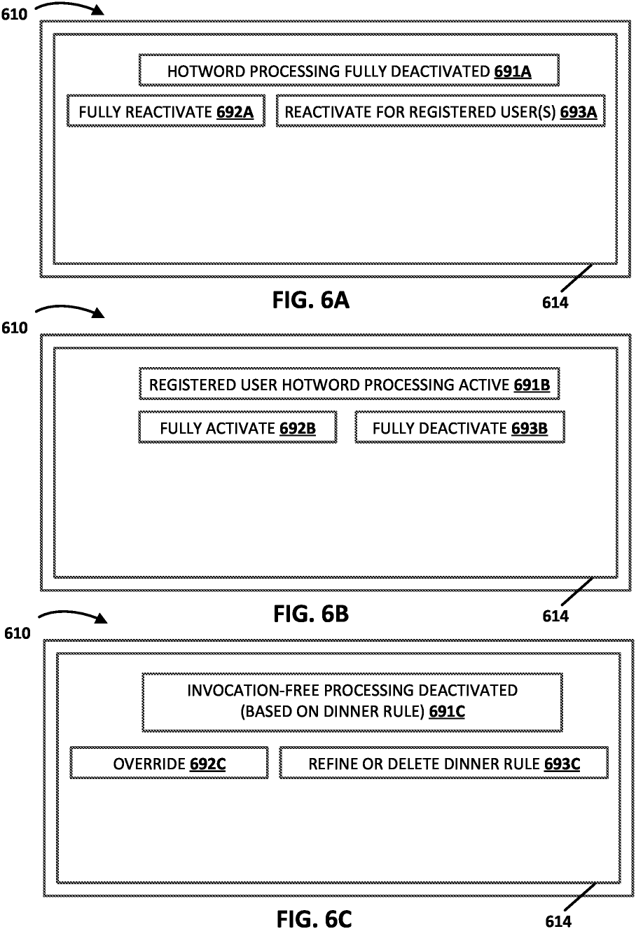

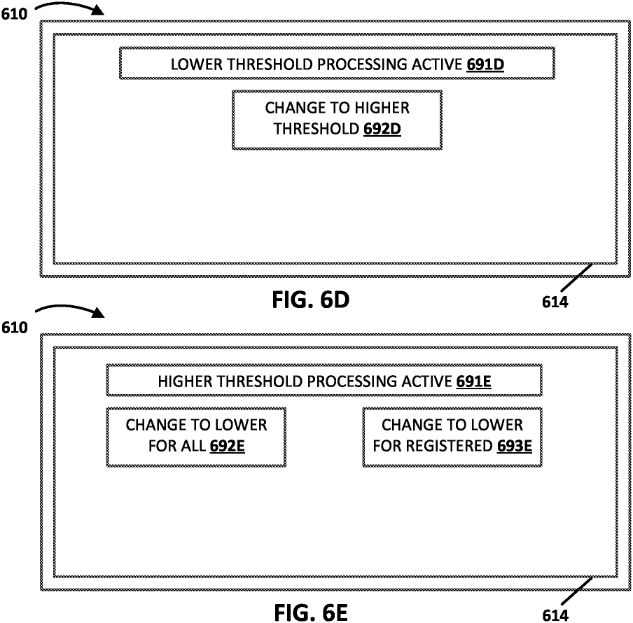

FIGS. 6A, 6B, 6C, 6D, and 6E illustrate an example assistant device 610 and examples of assistant device 610 visually rendering, on a display 614, user interface outputs that reflect a current automatically adapted state of audio data based assistant processing, as well as rendering feedback user interface elements.

FIG. 6A illustrates assistant device 610 rendering a graphical interface that includes an interface element 691A indicating that hot word processing has been automatically adapted to a fully inactive state. Further, FIG. 6A includes a first selectable element 692A and a second selectable element 693A. The first selectable element 692A can be selected and, in response to selection, the hot word processing can be switched to the fully active state and/or the selection can be used as feedback in, for example, training an adaptation ML model as described herein. The second selectable element 693A can be selected and, in response to selection, the hotword processing can be switched to a partially active state (e.g., activated for only registered users) and/or the selection can be used as feedback in, for example, training an adaptation ML model as described herein.

FIG. 6B illustrates assistant device 610 rendering a graphical interface that includes an interface element 691B indicating that hot word processing has been automatically adapted to a partially active state. Further, FIG. 6B includes a first selectable element 692B and a second selectable element 693B. The first selectable element 692B can be selected and, in response to selection, the hot word processing can be switched to the fully active state and/or the selection can be used as feedback in, for example, training an adaptation ML model as described herein. The second selectable element 693B can be selected and, in response to selection, the hotword processing can be switched to an inactive state and/or the selection can be used as feedback in, for example, training an adaptation ML model as described herein.

FIG. 6C illustrates assistant device 610 rendering a graphical interface that includes an interface element 691C indicating that invocation-free processing has been automatically adapted to an inactive state, and indicating that it was automatically adapted to the inactive state based on a “dinner rule”. Further, FIG. 6C includes a first selectable element 692C and a second selectable element 693C. The first selectable element 692C can be selected and, in response to selection, the invocation-free processing can be switched to a fully active state or a partially active state. The second selectable element 693C can be selected and, in response to selection, a further interface can be presented that enables the user to provide input(s) to delete and/or refine the dinner rule (e.g., refine temporal condition(s) for the rule).

FIG. 6D illustrates assistant device 610 rendering a graphical interface that includes an interface element 691D indicating that audio data based processing (e.g., hot word processing and/or invocation-free processing) has been automatically adapted to a lower threshold state. Further, FIG. 6D includes a first selectable element 692D that can be selected and, in response to selection, the audio data based processing can be switched to a higher threshold state and/or the selection can be used as feedback in, for example, training an adaptation ML model as described herein.

FIG. 6E illustrates assistant device 610 rendering a graphical interface that includes an interface element 691E indicating that audio data based processing (e.g., hot word processing and/or invocation-free processing) has been automatically adapted to a higher threshold state for registered users and guest users. Further, FIG. 6E includes a first selectable element 692E and a second selectable element 692E. First selectable element 692E can be selected and, in response to selection, the audio data based processing can be switched to a lower threshold state for registered users and guest users. Second selectable element 693E can be selected and, in response to selection, the audio data based processing can be switched to a lower threshold state for only registered users (i.e., maintained at the higher threshold state for guest users). A selection of element 692E or 693E can also be used as feedback in, for example, training an adaptation ML model as described herein.

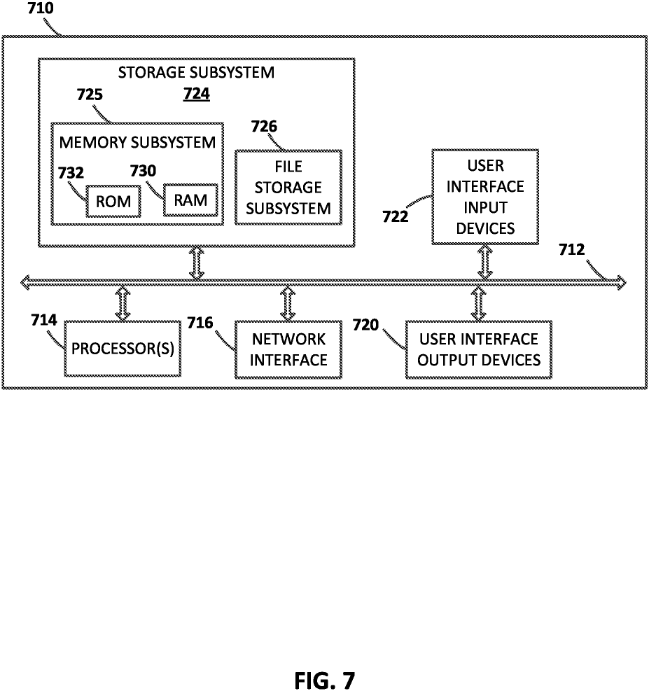

FIG. 7 is a block diagram of an example computing device 710 that may optionally be utilized to perform one or more aspects of techniques described herein. In some implementations, one or more of a client computing device, and/or other component(s) may comprise one or more components of the example computing device 710.

Computing device 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (“CRT”), a flat-panel device such as a liquid crystal display (“LCD”), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of one or more of the methods described herein, and/or to implement various components depicted herein.

These software modules are generally executed by processor 714 alone or in combination with other processors. Memory 725 used in the storage subsystem 724 can include a number of memories including a main random access memory (“RAM”) 730 for storage of instructions and data during program execution and a read only memory (“ROM”) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem may use multiple busses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

In situations in which the systems described herein collect personal information about users (or as often referred to herein, “participants”), or may make use of personal information, the users may be provided with an opportunity to control whether programs or features collect user information (e.g., information about a user’s social network, social actions or activities, profession, a user’s preferences, or a user’s current geographic location), or to control whether and/or how to receive content from the content server that may be more relevant to the user. Also, certain data may be treated in one or more ways before it is stored or used, so that personal identifiable information is removed. For example, a user’s identity may be treated so that no personal identifiable information can be determined for the user, or a user’s geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by processor(s) is provided that includes processing first values at a first time and, in response to the processing at the first time satisfying one or more first conditions: automatically adapting particular audio data based assistant processing, performed locally at an assistant device, to a second state and from a first state that is active at the first time. The first values, processed at the first time, are for dynamic contextual parameters at the first time. The method further includes processing second values at a second time and, in response to the processing at the second time satisfying one or more second conditions: automatically adapting the particular audio data based assistant processing, performed locally at the assistant device, to a third state. The adaptation to the third state is from one of the first state or the second state, and the one of the first state or the second state is active at the second time. The second values are for the dynamic contextual parameters at the second time.

These and other implementations disclosed herein can include one or more of the following features.

In some implementations, the first state is one of: (a) a fully active state in which the particular audio data based assistant processing is fully performed for one or more registered users that are registered with the assistant device and is also fully performed for any users that are not registered with the assistant device; (b) a partially active state in which the particular audio data based assistant processing is fully performed for at least some of the one or more registered users, but at least part of the particular audio data based assistant processing is suppressed for any users that are not registered with the assistant device; and (c) an inactive state in which the at least part of the particular audio data based assistant processing is suppressed for the one or more registered users and is also suppressed for any users that are not registered with the assistant device. In some versions of those implementations, the second state is another of: (a) the fully active state, (b) the partially active state, and (c) the inactive state and, optionally, the third state is the remaining of: (a) the fully active state, (b) the partially active state, and (c) the inactive state. In some hot word implementations of those versions, the particular audio data based assistant processing is hot word processing and the hot word processing includes: processing a stream of audio data, using one or more local hot word models of the assistant device, to monitor for occurrence of a hot word, the stream of audio data being detected via at least one microphone of the assistant device and; and causing further assistant processing to be performed based on detecting occurrence of the hot word in the stream of audio data. In some versions of the hot word implementations, in the partially active state, the particular audio data based assistant processing is suppressed, for any users that are not registered with the assistant device, by causing the further assistant processing to be performed further based on verifying that the hot word was uttered by one of the one or more registered users. In some of those versions, verifying that the hot word was uttered by one of the one or more registered users includes: processing, using a text-dependent speaker identification (TDSID) model, at least a portion of the stream of audio data that captures the hot word; and verifying that output, generated using the TDSID model based on the processing, matches a stored TDSID embedding for the one of the one or more registered users. In some versions of the hot word implementations, the hot word is an assistant hot word for invoking an automated assistant. In some of those versions, the further assistant processing includes: performing speech recognition, on audio data that captures a spoken utterance and that follows and/or precedes the hot word in the stream of audio data, to generate a recognition of the spoken utterance; performing natural language understanding, on the recognition, to generate natural language understanding data; and/or causing one or more actions to be performed based on the natural language understanding data. In some versions of the hot word implementations, the hot word is an action hot word for directly invoking a particular action via the automated assistant, and the further processing includes causing, by the automated assistant, the particular action to be performed based on detecting occurrence of the hot word in the stream of audio data. In some versions of the hot word implementations, the hot word is a third-party assistant application hot word for directly invoking a particular third-party application via the automated assistant, and the further processing includes causing, by the automated assistant, the particular third-party assistant application to be invoked based on detecting occurrence of the hot word in the stream of audio data. In some invocation-free implementations of those versions, the particular audio data based assistant processing is invocation-free speech recognition processing, the invocation-free speech recognition processing that includes: performing speech recognition, on audio data that captures a spoken utterance and using one or more local speech recognition models of the assistant device, to generate a recognition of the spoken utterance; determining, based on processing the recognition, whether the spoken utterance is an assistant command; and causing further assistant processing to be performed based on the spoken utterance being determined to be an assistant command. In some versions of the invocation-free implementations, in the partially active state, the particular audio data based assistant processing is suppressed, for any users that are not registered with the assistant device, by causing the further assistant processing to be performed further based on verifying that the spoken utterance was uttered by one of the one or more registered users. In some of those versions, verifying that the hot word was uttered by one of the one or more registered users includes: processing, using a text-independent speaker identification (TISID) model, at least a portion of the audio data that captures the spoken utterance; and verifying that output, generated using the TISID model based on the processing, matches a stored TISID embedding for the one of the one or more registered users. In some versions of the invocation-free implementations, the further assistant processing includes causing one or more actions to performed based on the recognition.

In some implementations, the first state is one of: (a) a first threshold state in which one or more first thresholds are utilized for the particular audio data based assistant processing;(a) a second threshold state in which one or more second thresholds are utilized for the particular audio data based assistant processing; and (c) an inactive state in which the particular audio data processing is suppressed for the one or more registered users and is suppressed for any users that are not registered with the assistant device. In some versions of those implementations, the second state is another of: the second state is another of: (a) the first threshold state, (b) the second threshold state, and (c) the inactive state and, optionally, the third state is the remaining of: (a) the first threshold state, (b) the second threshold state, and (c) the inactive state. In some hot word implementations of those versions, the particular audio data based assistant processing is hot word processing that includes: processing a stream of audio data, using one or more local hot word models of the assistant device, to monitor for occurrence of a hot word, the stream of audio data being detected via at least one microphone of the assistant device and; and causing further assistant processing to be performed based on detecting occurrence of the hot word in the stream of audio data. In some versions of those hot word implementations, in the first threshold state, a value, generated using the one or more local hot word models based on processing the stream of audio data, is compared to a first threshold, of the one or more first thresholds, in determining whether the hot word is detected in the stream of audio data - and, in the second threshold state, the value, generated using the one or more local hot word models based on processing the stream of audio data, is compared to a second threshold, of the one or more second thresholds, in determining whether the hot word is detected in the stream of audio data. In some invocation-free implementations of those versions, the particular audio data processing is invocation-free speech recognition processing, the invocation-free speech recognition processing that includes: performing speech recognition, on audio data that captures a spoken utterance and using one or more local speech recognition models of the assistant device, to generate a recognition of the spoken utterance; determining, based on processing the recognition, whether the spoken utterance is an assistant command; and causing further assistant processing to be performed based on the spoken utterance being determined to be an assistant command. In some versions of the invocation-free implementations, in the first threshold state, a value, generated in determining whether the spoken utterance is an assistant command, is compared to a first threshold of the one or more first thresholds - and, in the second threshold state, the value, generated in determining whether the spoken utterance is an assistant command, is compared to a second threshold of the one or more second thresholds.

In some implementations, the dynamic contextual parameters include: a registered user parameter that indicates whether one or more registered users are present in an environment of the assistant device and/or that indicates which of the one or more registered users are in the environment; a current activity parameter that indicates whether one or more activities are occurring in the environment and/or that indicates which of the one or more activities are occurring in the environment; and/or a temporal parameter that indicates one or more current temporal conditions. In some versions of those implementations, the dynamic contextual parameters include the registered user parameter. In some of those versions, a first registered user value, of the first values, for the registered user parameter is based on detecting that a given registered user, of the one or more registered users, is present in the environment at the first time. Detecting that the given registered user is present can optionally include: (a) performing voice-based speaker identification based on processing, at the assistant device, audio data detected at the assistant device, and/or (b) performing vision-based recognition based on processing, at the assistant device, vision data detected at the assistant device. In some additional or alternative versions of those implementations, the dynamic contextual parameters include the current activity parameter. In some of those additional or alternative versions, a first current activity value, of the first values, for the current activity user parameter is based on determining a given activity is currently occurring. Detecting that the given activity is currently occurring can optionally include: (a) performing audio-based activity identification based on processing, at the assistant device, audio data detected at the assistant device, and/or (b) accessing calendar information for one or more of the registered users.

In some implementations, processing the first values at the first time includes: processing the first values, using a trained adaptation machine learning model, to generate adaptation output. In some versions of those implementations, processing at the first time satisfying the one or more first conditions includes the adaptation output satisfying the one or more first conditions. In some implementations of those versions, the adaptation output includes at least one probability and the adaptation output satisfying the one or more first conditions includes the probability satisfying a first threshold. In some additional and/or alternative implementations of those versions, the trained adaptation machine learning model is trained based at least in part on implicit or explicit user feedback, detected at the assistant device, in response to prior automatic adaptations to the first state, the second state, and/or the third state.

In some implementations, at least a given first condition, of the one or more first conditions, is determined based on one or more prior instances of user interface input, from a registered user of the assistant device, that explicitly indicate the given first condition.

In some implementations, the method further includes: identifying an additional assistant device that is linked with the assistant device; in response to the processing at the first time satisfying one or more first conditions: automatically adapting the particular audio data based assistant processing, performed locally at the additional assistant device, to the second state and from the first state that is active at the additional assistant device at the first time; and in response to the processing at the second time satisfying one or more second conditions: automatically adapting the particular audio data based assistant processing, performed locally at the additional assistant device, to the third state. The adaptation to the third state being from one of the first state or the second state, where the one of the first state or the second state is active at the additional assistant device at the second time.

In some implementations, the method further includes: causing the assistant device to provide: first interface output in response to adaptation to the first state, second interface output in response to adaptation to the first state, and/or third interface output in response to adaptation to the first state. In some of those implementations, the first interface output is provided in response to adaptation to the first state and is enduring throughout the duration of the first state.

In some implementations, the first state is active at the first time responsive to a prior automatic adaptation, of the particular audio data based assistant processing, to the first state. In some of those implementations, automatically adapting the particular audio data based assistant processing, to the third state, is from the second state and the second state is active at the second time responsive to the adaptation to the second state at the first time.

In some implementations, the second state is a threshold state in which: one or more first thresholds are utilized, for the particular audio data based assistant processing, for one or more registered users that are registered with the assistant device, and one or more second thresholds are utilized, for the particular audio data based assistant processing, for any users that are not registered with the assistant device.

In some implementations, a method implemented by processor(s) is provided that includes processing, at a first time, first values for dynamic contextual parameters and, in response to the processing at the first time satisfying one or more first conditions: automatically adapting particular audio data based assistant processing, performed locally at an assistant device, to a second state and from a first state that is active at the first time. The first values are for the dynamic contextual parameters at the first time. The first state is one of: (a) a fully active state in which the particular audio data based assistant processing is fully performed for one or more registered users that are registered with the assistant device and is also fully performed for any users that are not registered with the assistant device; and (b) a partially active state in which the particular audio data based assistant processing is fully performed for at least some of the one or more registered users, but at least part of the particular audio data based assistant processing is suppressed for any users that are not registered with the assistant device. The second state is the other of (a) the fully active state and (b) the partially active state.

In some implementations, a method implemented by processor(s) is provided that includes processing, at a first time, first values for dynamic contextual parameters and, in response to the processing at the first time satisfying one or more first conditions: automatically adapting particular audio data based assistant processing, performed locally at an assistant device, to a second state and from a first state that is active at the first time. The first values are for the dynamic contextual parameters at the first time. The first state is one of: (a) a first threshold state in which one or more first thresholds are utilized for the particular audio data based assistant processing; and (b) a second threshold state in which one or more second thresholds are utilized for the particular audio data based assistant processing. The second state is the other of (a) the fully active state and (b) the partially active state.

In addition, some implementations may include a system including one or more computing devices (e.g., assistant device(s)), each with one or more processors and memory operably coupled with the one or more processors, where the memory of the one or more computing devices store instructions that, in response to execution of the instructions by the one or more processors of the one or more computing devices, cause the one or more processors to perform any of the methods described herein. Some implementations also include at least one non-transitory computer-readable medium including instructions that, in response to execution of the instructions by one or more processors, cause the one or more processors to perform any of the methods described herein.

What is claimed is:

1. A method implemented by one or more processors, the method comprising:
processing, at a first time, first values, wherein the first values are for dynamic contextual parameters at the first time;
in response to the processing at the first time satisfying one or more first conditions:
automatically adapting particular audio data based assistant processing, performed locally at an assistant device, to a second state and from a first state that is active at the first time;
processing, at a second time, second values, wherein the second values are for the dynamic contextual parameters at the second time;
in response to the processing at the second time satisfying one or more second conditions:
automatically adapting the particular audio data based assistant processing, performed locally at the assistant device, to a third state, the adaptation to the third state being from one of the first state or the second state, the one of the first state or the second state being active at the second time.

2. The method of claim 1, wherein the first state is one of:
(a) a fully active state in which the particular audio data based assistant processing is fully performed for one or more registered users that are registered with the assistant device and is also fully performed for any users that are not registered with the assistant device;
(b) a partially active state in which the particular audio data based assistant processing is fully performed for at least some of the one or more registered users, but at least part of the particular audio data based assistant processing is suppressed for any users that are not registered with the assistant device; and
(c) an inactive state in which the at least part of the particular audio data based assistant processing is suppressed for the one or more registered users and is also suppressed for any users that are not registered with the assistant device.

3. The method of claim 2, wherein the second state is another of: (a) the fully active state, (b) the partially active state, and (c) the inactive state.

4. The method of claim 3, wherein the third state is the remaining of: (a) the fully active state, (b) the partially active state, and (c) the inactive state.

5. The method of claim 4, wherein the particular audio data based assistant processing is hot word processing, the hot word processing comprising:
processing a stream of audio data, using one or more local hot word models of the assistant device, to monitor for occurrence of a hot word, the stream of audio data being detected via at least one microphone of the assistant device and; and
causing further assistant processing to be performed based on detecting occurrence of the hot word in the stream of audio data.

6. The method of claim 5, wherein, in the partially active state, the particular audio data based assistant processing is suppressed, for any users that are not registered with the assistant device, by causing the further assistant processing to be performed further based on:
verifying that the hot word was uttered by one of the one or more registered users.

7. The method of claim 6, wherein verifying that the hot word was uttered by one of the one or more registered users comprises:
processing, using a text-dependent speaker identification (TDSID) model, at least a portion of the stream of audio data that captures the hot word; and
verifying that output, generated using the TDSID model based on the processing, matches a stored TDSID embedding for the one of the one or more registered users.

8. The method of claim 5, wherein the hot word is an assistant hot word for invoking an automated assistant.

9. The method of claim 8, wherein the further assistant processing comprises:
performing speech recognition, on audio data that captures a spoken utterance and that follows and/or precedes the hot word in the stream of audio data, to generate a recognition of the spoken utterance;
performing natural language understanding, on the recognition, to generate natural language understanding data; and/or
causing one or more actions to be performed based on the natural language understanding data.

10. The method of claim 5, wherein the hot word is an action hot word for directly invoking a particular action via the automated assistant, and wherein the further processing comprises causing, by the automated assistant, the particular action to be performed based on detecting occurrence of the hot word in the stream of audio data.

11. The method of claim 5, wherein the hot word is a third-party assistant application hot word for directly invoking a particular third-party application via the automated assistant, and wherein the further processing comprises causing, by the automated assistant, the particular third-party assistant application to be invoked based on detecting occurrence of the hot word in the stream of audio data.

12. The method of claim 4, wherein the particular audio data processing is invocation-free speech recognition processing, the invocation-free speech recognition processing comprising:
performing speech recognition, on audio data that captures a spoken utterance and using one or more local speech recognition models of the assistant device, to generate a recognition of the spoken utterance;
determining, based on processing the recognition, whether the spoken utterance is an assistant command; and
causing further assistant processing to be performed based on the spoken utterance being determined to be an assistant command.

13. The method of claim 12, wherein, in the partially active state, the particular audio data based assistant processing is suppressed, for any users that are not registered with the assistant device, by causing the further assistant processing to be performed further based on:
verifying that the spoken utterance was uttered by one of the one or more registered users.

14. The method of claim 13, wherein verifying that the hot word was uttered by one of the one or more registered users comprises:
processing, using a text-independent speaker identification (TISID) model, at least a portion of the audio data that captures the spoken utterance; and
verifying that output, generated using the TISID model based on the processing, matches a stored TISID embedding for the one of the one or more registered users.

15. The method of claim 12, wherein the further assistant processing comprises:
causing one or more actions to performed based on the recognition.

16. The method of claim 1, wherein the first state is one of:
(a) a first threshold state in which one or more first thresholds are utilized for the particular audio data based assistant processing;
(a) a second threshold state in which one or more second thresholds are utilized for the particular audio data based assistant processing; and
(c) an inactive state in which the particular audio data processing is suppressed for the one or more registered users and is suppressed for any users that are not registered with the assistant device.

17. The method of claim 16, wherein the second state is another of: (a) the first threshold state, (b) the second threshold state, and (c) the inactive state; and/or wherein the third state is the remaining of: (a) the first threshold state, (b) the second threshold state, and (c) the inactive state.

18. The method of claim 17, wherein the particular audio data based assistant processing is hot word processing, the hot word processing comprising:
processing a stream of audio data, using one or more local hot word models of the assistant device, to monitor for occurrence of a hot word, the stream of audio data being detected via at least one microphone of the assistant device and; and
causing further assistant processing to be performed based on detecting occurrence of the hot word in the stream of audio data;
wherein in the first threshold state, a value, generated using the one or more local hot word models based on processing the stream of audio data, is compared to a first threshold, of the one or more first thresholds, in determining whether the hot word is detected in the stream of audio data, and
wherein in the second threshold state, the value, generated using the one or more local hot word models based on processing the stream of audio data, is compared to a second threshold, of the one or more second thresholds, in determining whether the hot word is detected in the stream of audio data.

19. A method implemented by one or more processors, the method comprising:
processing, at a first time, first values, for dynamic contextual parameters, at the first time;
in response to the processing at the first time satisfying one or more first conditions:
automatically adapting particular audio data based assistant processing, performed locally at an assistant device, to a second state and from a first state that is active at the first time,
wherein the first state is one of:
(a) a fully active state in which the particular audio data based assistant processing is fully performed for one or more registered users that are registered with the assistant device and is also fully performed for any users that are not registered with the assistant device; and
(b) a partially active state in which the particular audio data based assistant processing is fully performed for at least some of the one or more registered users, but at least part of the particular audio data based assistant processing is suppressed for any users that are not registered with the assistant device; and
wherein the second state is the other of (a) the fully active state and (b) the partially active state.

20. A method implemented by one or more processors, the method comprising:
processing, at a first time, first values, for dynamic contextual parameters, at the first time;
in response to the processing at the first time satisfying one or more first conditions:
automatically adapting particular audio data based assistant processing, performed locally at an assistant device, to a second state and from a first state that is active at the first time,
wherein the first state is one of:
(a) a first threshold state in which one or more first thresholds are utilized for the particular audio data based assistant processing;
(b) a second threshold state in which one or more second thresholds are utilized for the particular audio data based assistant processing; and
wherein the second state is the other of (a) the fully active state and (b) the partially active state.
